(19) United States
(12) Patent Application Publication
(10) Pub. No.: US 2010/0281185 A1
(43) Pub. Date: Nov. 4, 2010

(54) COMMUNICATION DEVICE, CONTROL METHOD FOR COMMUNICATION DEVICE, AND COMPUTER PROGRAM PRODUCT

(76) Inventor: Hajime TAKAYAMA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/767,075

(22) Filed: Apr. 26, 2010

(30) Foreign Application Priority Data
May 1, 2009 (JP) 2009-112118
Feb. 26, 2010 (JP) 2010-043239

(51) Int. Cl. G06F 3/00

(52) U.S. Cl. 710/14; 713/323

(57) ABSTRACT

A communication device includes a connecting unit that connects another device; a communicating unit that performs communication with the other device via the connecting unit by using a signal in accordance with a communication request; and a controlling unit that controls a state of the connecting unit to be in either one of a first state in which the communication can be performed by the communicating unit and a second state in which the communication is not performed by the communicating unit and electrical power consumption of the connecting unit is reduced, wherein the controlling unit shifts the state of the connecting unit from the first state to the second state, when the connecting unit to which the other device is connected is in the first state, and if the communication request to the communicating unit is not received for a predetermined period of time.

### CROSS-REFERENCE TO RELATED APPLICATIONS

The present application claims priority to and incorporates by reference the entire contents of Japanese Patent Application No. 2009-112118 filed in Japan on May 1, 2009 and Japanese Patent Application No. 2010-043239 filed in Japan on Feb. 26, 2010.

### BACKGROUND OF THE INVENTION

1. Field of the Invention

The present invention relates to a communication device, a control method for the communication device, and a computer program product.

2. Description of the Related Art

Conventionally, as a method of connecting electronic devices, a universal serial bus (USB) connection is widely used in which a host machine and a plurality of peripheral devices (devices) are connected using serial communication.

One of the features of a USB is a plug and play function in which, when a peripheral device is newly connected to the host machine, the connection relation with the peripheral device is automatically recognized. Furthermore, the USB also has a hot swapping function, in which a peripheral device can be connected to and disconnected from the host machine while the power being turned on. With these functions, when a user connects a peripheral device, the USB is designed taking into consideration that the user cannot be bothered in setting an address and an ID number for the peripheral device to be connected and switching on power supply for the peripheral device.

With the conventional technology, when a USB connection is performed, a personal computer usually serves as the host machine. In contrast, in recent years, a method has been proposed in which a device installed in an electronic device is connected via the USB in order to use it the same as an external device that is connected to the USB from outside. For example, secondary storage devices or authentication devices, such as built-in hard disk drives, and devices that are used to implement a user interface (UI) such as numeric keypads or displays are internally connected using a USB.

In such a case, with a USB connection, the electronic device serving as the host machine may, in some cases, need to supply power to devices that are connected using a USB. Even when devices internally installed are connected using a USB, there is a need to take into consideration the power supply performance of the entire system, such as the electrical power supply to the connected devices and the electrical power consumption that is controlled by devices.

In the technology disclosed in Japanese Patent No. 4125328, it is dynamically determined whether a connected device satisfies a suspended state that conforms to the USB standard, and, if it is determined that the connected device satisfies the suspended state, when no host machine accesses to a USB connection device, the state of the USB connection device is forced to shift to the suspended state.

However, the technology disclosed in Japanese Patent No. 4125328 shifts a state of the device that is connected to the host machine using a USB into the suspended state, but does not control the low electrical power consumption state of the host machine.

In particular, in recent years, because reducing electrical power consumption has been an important issue, a case of increasing the minimum electrical power consumption due to a USB connection needs to be avoided as much as possible.

### SUMMARY OF THE INVENTION

It is an object of the present invention to at least partially solve the problems in the conventional technology.

According to an aspect of the present invention, there is provided a communication device including a connecting unit that connects another device; a communicating unit that performs communication with the other device via the connecting unit by using a signal in accordance with a communication request; and a controlling unit that controls a state of the connecting unit to be in either one of a first state in which the communication can be performed by the communicating unit and a second state in which the communication is not performed by the communicating unit and electrical power consumption of the connecting unit is reduced, wherein the controlling unit shifts the state of the connecting unit from the first state to the second state, when the connecting unit to which the other device is connected is in the first state, and if the communication request to the communicating unit is not received for a predetermined period of time.

According to another aspect of the present invention, there is provided a communication control method in a communication device including communicating, via a connecting unit and by a communicating unit, with another device by using a signal in accordance with a communication request, and controlling, by a controlling unit, a state of the connecting unit to be in either one of a first state in which the communication can be performed by the communicating and a second state in which the communication is not performed by the communicating and electrical power consumption of the connecting unit is reduced, wherein the controlling includes shifting the state of the connecting unit from the first state to the second state, when the connecting unit to which the other device is connected is in the first state, and if the communication request to the communication is not received for a predetermined period of time.

According to still another aspect of the present invention, there is provided a computer program product including a computer-usable medium having computer-readable program codes embodied in the medium for processing communication in a communication device, the program codes when executed causing a computer to execute communicating, via a connecting unit and by a communicating unit, with another device by using a signal in accordance with a communication request, and controlling, by a controlling unit, a state of the connecting unit to be in either one of a first state in which the communication can be performed by the communicating and a second state in which the communication is not performed by the communicating and electrical power consumption of the connecting unit is reduced, wherein the controlling includes shifting the state of the connecting unit from the first state to the second state, when the connecting unit to which the other device is connected is in the first state, and if the communication request to the communication is not received for a predetermined period of time.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating, in outline, a connection state of a device that can be applied to an embodiment;

FIG. 2 is a state transition diagram illustrating a state transition of a bus in a USB, which is commonly used in the embodiment and modifications of the embodiment;

FIG. 3 is a state transition diagram illustrating, in detail, a state transition of the bus in the USB, which is commonly used in an embodiment and modifications;

FIG. 4 is a functional block diagram explaining a function of a USB communication device according to the embodiment;

FIG. 5 is a sequence chart illustrating an example of a shift operation in which a state of a connecting device according to the embodiment is shifted to a low electrical power consumption state;

FIG. 6 is a schematic diagram illustrating an example of identification information;

FIG. 7 is a schematic diagram illustrating an example of a list of already-known identification information;

FIG. 8 is a flowchart illustrating an example process for determining availability of shifting to a suspended state in a first modification of the embodiment;

FIG. 9 is a table illustrating identification information contained in a USB device and connection points are held in an associated manner;

FIG. 10 is a flowchart illustrating an example process for determining availability of shifting to the suspended state in a second modification of the embodiment; and

FIG. 11 is a block diagram illustrating, in outline, an example configuration of an MFP serving as a host-side device that can be applied to the embodiment and the modifications.

### DETAILED DESCRIPTION OF THE PREFERRED EMBODIMENTS

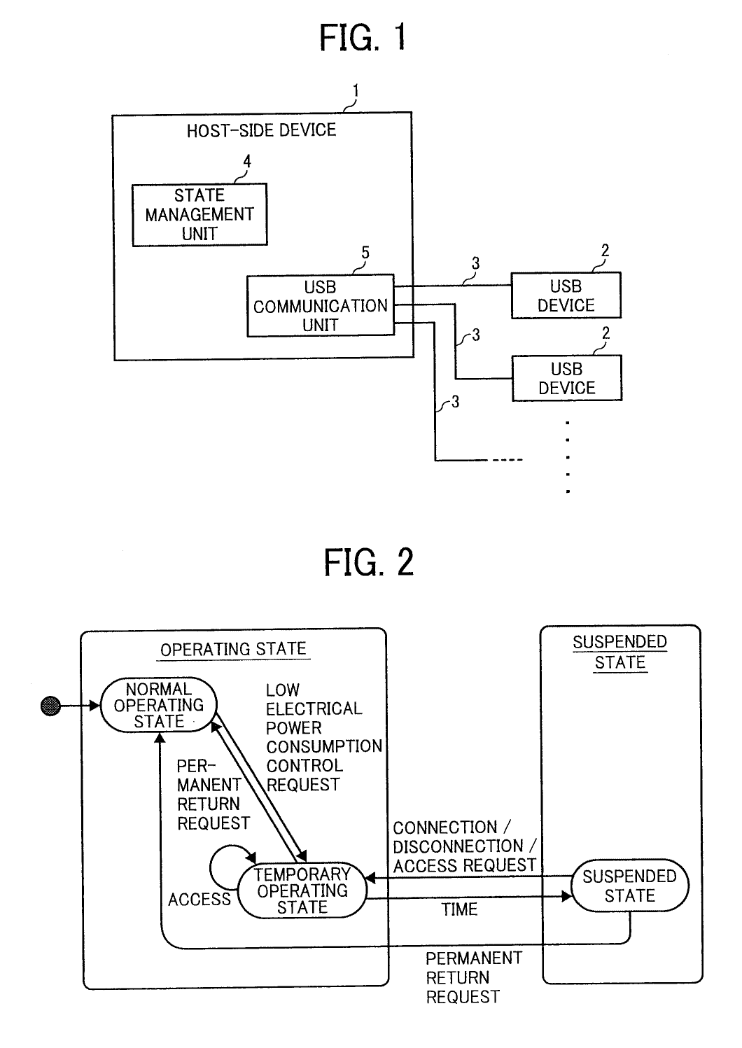

An exemplary embodiment of a communication device according to the present invention will be described in detail below with reference to the accompanying drawings. FIG. 1 is a schematic diagram illustrating, in outline, the connection state of a device that can be applied to the present embodiment. USB devices 2 serving as external connection devices are connected to, using USB cables 3, a host-side device 1 that serves as a host machine for a universal serial bus (USB) connection.

The host-side device 1 has a USB communication device 5 that performs communication using a USB and serves as a USB host and a state management device 4 that manages a state of the USB communication device 5. The state management device 4 manages the state of the entire system. For the state of the USB communication device 5, the state management device 4 manages the state of low electrical power consumption control (low electrical power consumption state) in which electrical power consumption is reduced and manages a full active state in which a communication process is given high priority. The USB communication device 5 has a plurality of ports for a USB connection and can control communication with the USB devices 2 that are connected to the ports.

In FIG. 1, the USB devices 2 are externally connected to the host-side device 1; however, the configuration is not limited thereto. For example, the USB devices 2 can be devices that are installed inside of the host-side device 1. In such a case, the host-side device 1 and the USB devices 2 can not only be connected via the USB cables 3 but also be connected, for example, as a circuit installed in the devices. Furthermore, both the USB devices 2 that are externally connected to the host-side device 1 and devices installed in the host-side device 1 can be connected to the USB communication device 5.

FIG. 2 is a state transition diagram illustrating a state transition of a bus in a USB, which is commonly used in the embodiment and modifications of the present invention. In the USB, a bus has substantially two states: an operating state and a suspended state.

The operating state is a state in which the bus is in an active state. In the operating state, a start of frame (SOF), which indicates the starting of a frame, is sent to the USB devices 2 at predetermined intervals. Furthermore, in the operating state, power is supplied from the USB communication device 5 to the USB devices 2 via the USB cables 3.

The operating state includes a normal operating state and a temporary operating state. The normal operating state is a state in which communication using the bus can be always performed. In the operating state, when the USB communication device 5 receives, from the state management device 4 in the system, a request for a low electrical power consumption state, the USB communication device 5 transits a state of the bus from the normal operating state to the temporary operating state. In the temporary operating state, if there is no change in the state of the bus, e.g., a new connection, a connection release, and an access request to the bus, for a predetermined period of time, the state of the USB communication device 5 is transited from the operating state to the suspended state.

The suspended state is a state in which the bus is in an idle state. For example, in the suspended state, transmission of the SOF to the USB devices 2 is stopped and power supplies to the USB devices 2 are controlled. Accordingly, electrical power consumption by the USB communication device 5 can be reduced. If the state of the bus is changed, the suspended state is temporarily returned and transited to the operating state. In the suspended state, the connected USB devices 2 are expected to shift to a power-saving mode.

Furthermore, if the state management device 4 in the system determines that reducing the time needed for a shift process between the temporary operating state in a low electrical power consumption state and the suspended state is more effective than the power-saving effect due to a low electrical power consumption control, the state management device 4 sends a permanent return request to the USB communication device 5. In accordance with the permanent return request, the state of the USB communication device 5 is transited from the temporary operating state or the suspended state to the normal operating state, and then the bus is in a fully active state.

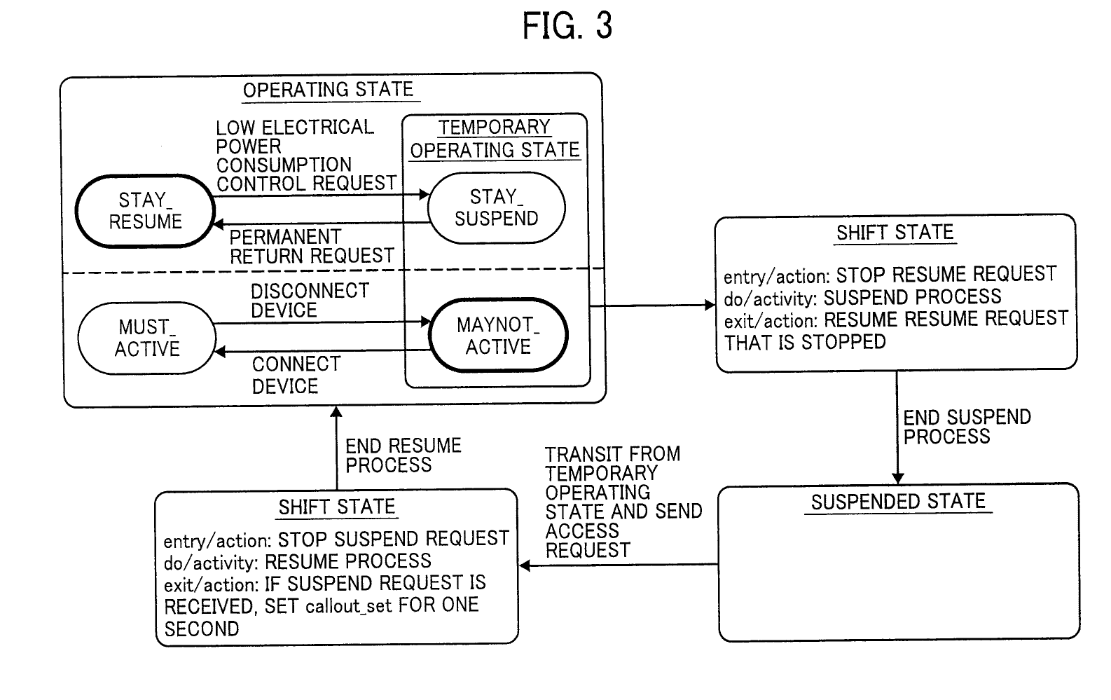

FIG. 3 illustrates, in more detail, the state transition that is illustrated FIG. 2. The operating state has four states: two states concerning whether the low electrical power consumption control is performed, i.e., a STAY_RESUME state and a STAY_SUSPEND state and two states concerning the connection states of the USB devices 2, i.e., a MUST_ACTIVE state and a MAYNOT_ACTIVE state.

The STAY_RESUME state is a state in which the permanent return request is received. The STAY_SUSPEND state is a state in which a low electrical power consumption shift request is received. The MUST_ACTIVE state is a state in which the bus needs to be in the active state. The MAYNOT_ACTIVE state is a state in which the bus does not need to be in the active state. The MUST_ACTIVE state and the MAYNOT_ACTIVE state are transited when the USB devices 2 that are externally connected to the host-side device 1 is in a connection state. For example, when at least one USB device 2, which is an external device, is connected to a USB port, the state thereof is the MUST_ACTIVE state, whereas when the USB device 2 is disconnected, the state thereof is the MAYNOT_ACTIVE state.

If the state is the STAY_SUSPEND state and also the MAYNOT _ACTIVE state, that state corresponds to the temporary operating state; therefore, state transition from the operating state to the suspended state can be performed. In contrast, if the state is the STAY_RESUME state or the MUST _ACTIVE state, that state corresponds to the normal operating state; therefore, the bus is in the full active state.

A predetermined time is needed for the state transition between the operating state and the suspended state. The shift state illustrated in FIG. 3 is the transitional state from the operating state to the suspended state or from the suspended state to the operating state.

In the shift state in which a state is transited from the operating state to the suspended state, the USB communication device 5 stops receiving a resume request and then performs a shift process for shifting a state to the suspended state. Upon completion of the shift process, the bus is in the suspended state. At this time, if there is any held resume request to be received, the USB communication device 5 receives that request and starts execution. In the shift state in which a state is transited from the suspended state to the subsequent operating state, the USB communication device 5 first stops receiving a suspend request and then performs a resume process for returning to the subsequent operating state. If the USB communication device 5 receives a suspend request upon completion of the resume process, the USB communication device 5 transits to the suspended state a predetermined period of time after the suspended state returns to the operating state (for example, after one second).

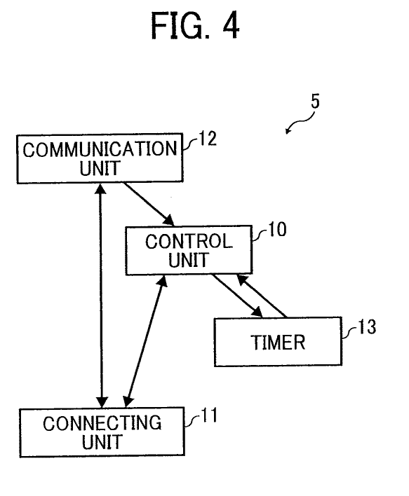

In the following, the operation that is described with reference to FIGS. 2 and 3 will be described in detail. FIG. 4 is a functional block diagram explaining a function of the USB communication device 5 illustrated in FIG. 1. As illustrated in FIG. 4, the USB communication device 5 has a control device 10, a connecting device 11, a communication device 12 and a timer 13. The control device 10 controls the communication performed by the USB communication device 5 and the state of the bus. The connecting device 11, which performs the basic functions of a USB, makes a physical connection to the USB devices 2 and detects a physical connection to and disconnection from the USB devices 2. Furthermore, the connecting device 11 can supply power to the USB devices 2 that are physically connected thereto. The communication device 12 performs data communication using the bus in accordance with a request from the host system. The timer 13 measures a time in accordance with control performed by the control device 10. The timer 13 is reset when it is started up and then a predetermined notice time of expiration is set thereto.

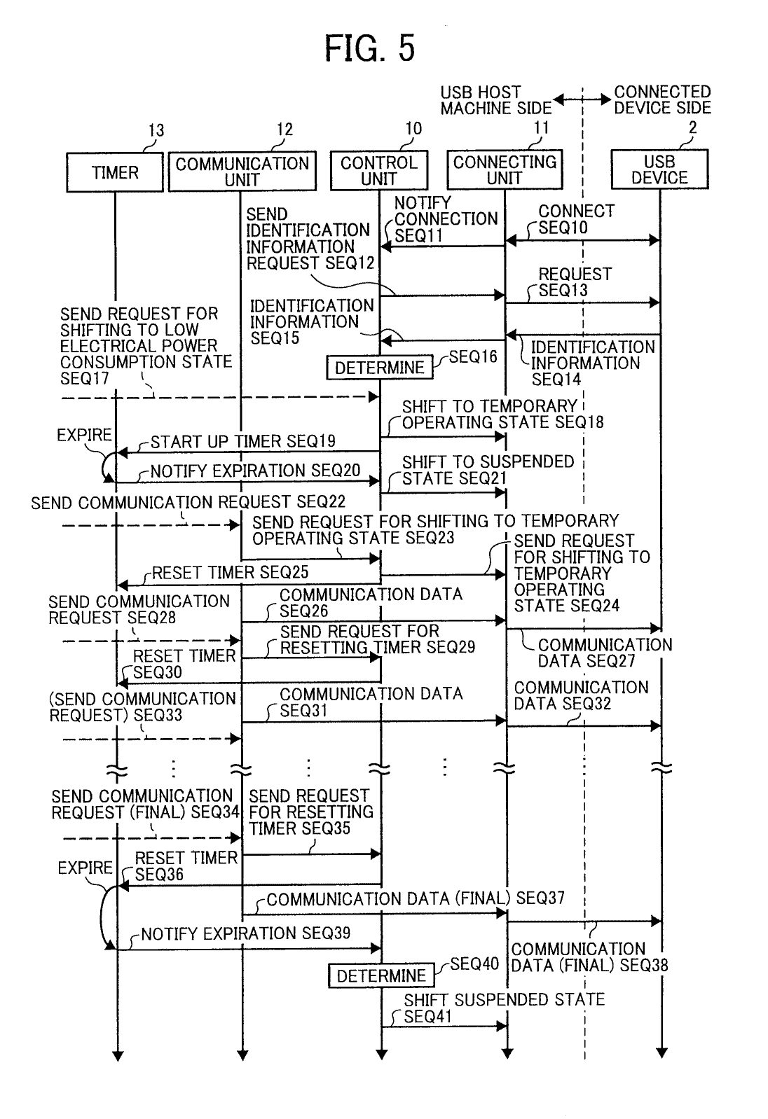

An example of a shift operation, in which the state of the connecting device 11 according to the embodiment is shifted to a low electrical power consumption state, will be described in detail with reference to the sequence chart illustrated in FIG. 5. If the connecting device 11 detects a connection to the USB device 2 (SEQ10), the connecting device 11 notifies the control device 10 of that state (SEQ11).

In a USB, a process for obtaining information, which is called descriptor, from a device is performed during enumeration when a connection is performed. The descriptor includes device descriptors, configuration descriptors, interface descriptors, end point descriptors, and the like. Of these descriptors, in the device descriptors, a lot of identification information related to devices, such as manufacturing company names (vendor IDs) and production numbers (product IDs) are contained.

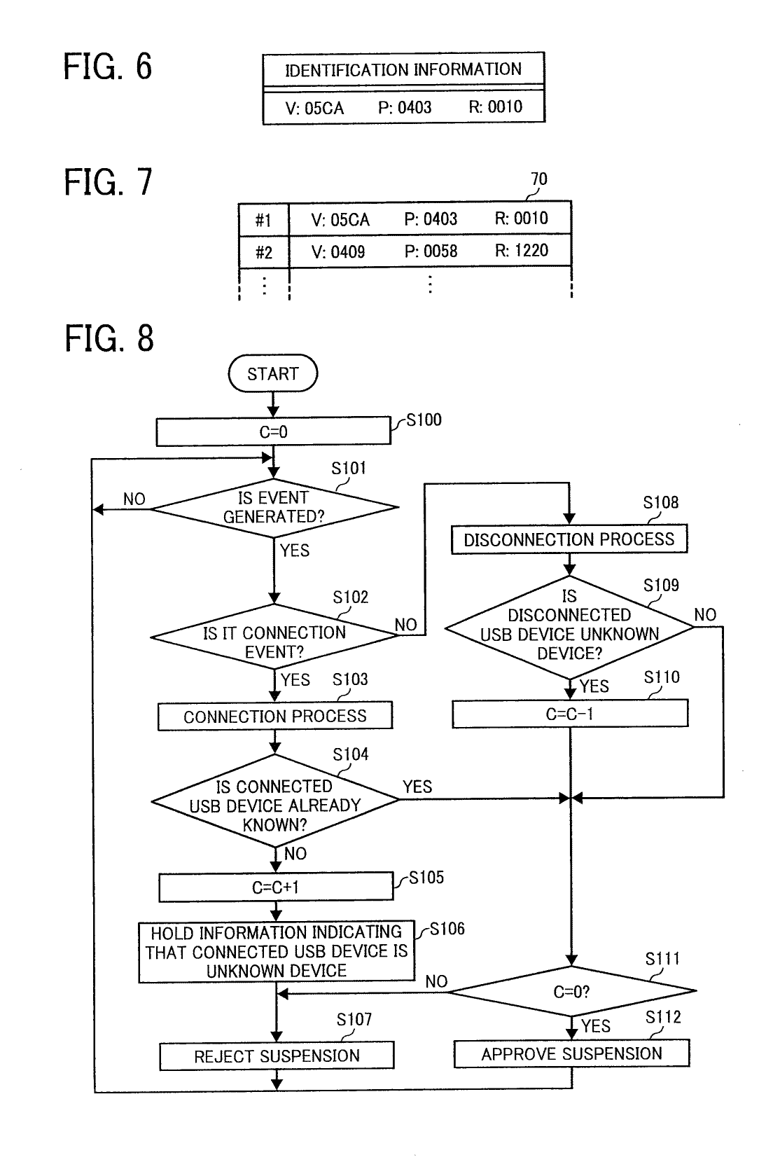

FIG. 6 is a schematic diagram illustrating, from among information contained in the device descriptor, example information that is used as identification information in the embodiment. In FIG. 6, a “V”, a “P” and an “R” indicate information, contained in the device descriptor, that is respectively described in an idVender field, an idProduct field, and a bcdDevice field. The idVender field represents, for example, the manufacturing company's name that produces the USB device 2. The idProduct field represents, for example, the production number of the USB device 2. The bcdDevice field represents, for example, the release number of the USB device 2. By combining the information described in the idVender field, the idProduct field, and the bcdDevice field, it is possible to specify the device.

If the control device 10 receives a notice that the USB device 2 is connected, the control device 10 sends a request for the identification information to the USB device 2 via the connecting device 11 (SEQ12 and SEQ13). In response to this request, the identification information that is sent from the USB device 2 is obtained by the control device 10 via the connecting device 11 (SEQ14 and SEQ15). The control device 10 holds the obtained identification information until a disconnection of the USB device 2 that obtains the identification information is detected.

The control device 10 compares the identification information obtained from the USB device 2 with a list of already-known identification information that is stored in advance. As a result of the comparison, if all the pieces of identification information obtained from the connected USB devices 2 are registered in the list of the already-known identification information, the control device 10 determines that the state of the connecting device 11 can be shifted to the suspended state (SEQ16).

The list of the already-known identification information is (for example, see a list 70 illustrated in FIG. 7) provided in a program that is used to implement a function of the control device 10, by combining, in advance, the vendor IDs, the product IDs, and the release numbers described using FIG. 6. However, the configuration is not limited thereto. For example, the list 70 can be provided by creating data separated from the program and storing the data in, for example, a read only memory (ROM) (not shown) or can be provided from outside the host-side device 1 via a communication or a storage medium.

In the following, an operation will be described of a case in which it is determined that the state of the connecting device 11 can be shifted to the suspended state at SEQ16, and the state of the USB communication device 5 is shifted to the low electrical power consumption state in accordance with a request from the state management device 4.

A request for shifting to the low electrical power consumption state is sent from the state management device 4 to the USB communication device 5 (SEQ17). In accordance with the request for shifting to the low electrical power consumption state, the control device 10 shifts the state of the connecting device 11 to the temporary operating state in the low electrical power consumption state (SEQ18) and starts up the timer 13 (SEQ19). When the timer 13 is started up, the timer 13 measures the time by incrementing a timer value at predetermined time intervals. If the timer value reaches a predetermined value that is set in advance, the timer 13 notifies the control device 10 of the expiration of the timer value (SEQ20). When the control device 10 receives an expiration notice from the timer 13, the control device 10 shifts the state of the connecting device 11 to the suspended state (SEQ21).

The communication device 12 shares, with the connecting device 11, information on whether the connecting device 11 is in the low electrical power consumption state. If the communication, via the connecting device 11, performed by the USB communication device 5 is needed due to an operation performed by the host-side device 1, the communication device 12 confirms the state of the connecting device 11. As a result thereof, if the connecting device 11 is in the suspended state in the low electrical power consumption state, the communication device 12 sends, to the control device 10, a request for shifting the state of the connecting device 11 to the temporary operating state.

For example, if the communication device 12 receives a communication request from the host system (SEQ22), the communication device 12 sends, to the control device 10, a request for shifting the state of the connecting device 11 to the temporary operating state (SEQ23). In response to the request, the control device 10 shifts the state of the connecting device 11 to the temporary operating state in the low electrical power consumption state (SEQ24) and starts up the timer 13. Specifically, the control device 10 resets the timer value of the timer 13 to zero (SEQ25), sets the time at which expiration is notified, and starts incrementing the timer value.

For example, communication data supplied from the host system is delivered from the communication device 12 to the connecting device 11 (SEQ26), and is sent from the connecting device 11 to the USB device 2 via the USB cable 3 (SEQ27).

Subsequently, every time the communication device 12 receives a new communication request, the communication device 12 gives an instruction, via the control device 10, to reset the timer value of the timer 13, to set a notice time of expiration, and to start incrementing the timer value, and then restarts the timer 13. Specifically, if the communication device 12 receives a new communication request (SEQ28), the communication device 12 performs some operations such as resetting, via the control device 10, the timer value of the timer 13, and then restarts the timer 13 (SEQ29 and SEQ30) and delivers the communication data to the connecting device 11 (SEQ31). The connecting device 11 sends the communication data received from the communication device 12 to the USB device 2 (SEQ32). When the communication device 12 subsequently receives a communication request (SEQ33), the same process as that performed after restarting the timer 13 is repeated.

If a communication request is not received for a predetermined time and if the timer value of the timer 13 reaches the notice time of the expiration, the timer 13 notifies the control device 10 of the expiration (SEQ39).

For example, in accordance with a communication request (SEQ34), in a similar manner as described above, the communication device 12 performs some operations such as resets, via the control device 10, the timer value of the timer 13, and then restarts the timer 13 (SEQ35, SEQ36) and delivers communication data to the connecting device 11 (SEQ37). The connecting device 11 sends the communication data to the USB device 2 (SEQ38). If a set expiration time has elapsed after the timer 13 is restarted in accordance with the communication request at SEQ34, the timer 13 notifies the control device 10 of the expiration (SEQ39).

The control device 10 that receives the expiration notice determines whether, in a similar manner as in SEQ16, the state of the connecting device 11 can be shifted to the suspended state (SEQ40). If the control device 10 determines that the shift can be performed, the control device 10 again shifts the state of the connecting device 11 to the suspended state (SEQ41). Specifically, the control device 10 compares the identification information on the currently connected USB device 2 with the list 70 of the already-known identification information that is stored in advance. If all of the pieces of identification information on the currently connected USB devices 2 are registered in the list 70 of the already-known identification information, the control device 10 determines that it is possible to shift the state of the connecting device 11 to the suspended state.

When the system is in full operation, if it is determined that reducing the time, which is needed for a state transition between the suspended state and the temporary operating state of the USB, is more effective than power saving being performed in a low electrical power consumption control, the state management device 4 for the entire system sends a permanent return request to the control device 10. When the control device 10 receives the permanent return request, the control device 10 performs an operation for making the state of the connecting device 11 return to the normal operating state without starting up the timer 13.

Furthermore, when the system is not in full operation and is in a state in which the effect of power-saving of the USB is given priority, the state management device 4 sends, to the control device 10, a request for shifting to low electrical power consumption state. At this time, for example, in a similar manner as in the case in which the shift request for the low electrical power consumption state is received at SEQ17, the control device 10 resets the timer value of the timer 13, sets a time for requesting an expiration notice, and starts up the timer 13.

In the above description, a single USB device 2 is connected to the USB communication device 5 in the host-side device 1; however, the configuration is not limited thereto. For example, the embodiment can be applied to a case in which a plurality of USB devices 2 is connected to the USB communication device 5. In such a case, every time an additional USB device 2 is connected to the USB communication device 5, the processes from SEQ10 to SEQ15 are performed. Furthermore, the processes starting from SEQ16 or from SEQ17 are performed on all of the USB devices 2 connected to the USB communication device 5.

As described above, according to the embodiment of the present invention, the connecting device 11 is configured such that the state thereof does not shift to the suspended state while communication is being performed by the USB but shifts to the suspended state a predetermined period of time after the communication has stopped. Accordingly, it is possible to properly reduce the electrical power consumption of the connecting device 11.

In the following, a first modification of the embodiment will be described. In the first modification, in addition to the processes performed in the embodiment described above, of the USB devices 2 connected to the USB communication device 5, the number of USB devices 2 that is unknown by the USB communication device 5 is counted. Then, only when the number of unknown USB devices 2 is zero, it is determined that the state of the connecting device 11 can be shifted to the suspended state. If the number of unknown USB devices 2 is not zero, the state of the connecting device 11 is not shifted to the suspended state.

For example, the determination whether, in accordance with the number of unknown USB devices 2, the state of the connecting device 11 can be shifted to the suspended state is performed when a process of SEQ16 or SEQ40 illustrated in FIG. 5 described above is performed. If it is determined that the number of currently connected unknown USB devices 2 is not zero, it is determined that the state of the connecting device 11 cannot be shifted to the suspended state, and the process for shifting to the suspended state is not performed at SEQ21 or SEQ41.

More specifically, the control device 10 has a counter for counting the number of unknown devices that are connected and resets the count value of the counter to zero when, for example, the system is started up. In a similar manner as in the processes of SEQ10 to SEQ15 illustrated in FIG. 5, the control device 10 obtains identification information on the USB device 2 whose connection is notified by the connecting device 11. Then, the control device 10 compares the obtained identification information with the list 70 of the already-known identification information that is stored in advance. If the obtained identification information is not registered in the list 70 of already-known identification information, the control device 10 increments the count value of the counter that counts the number of unknown connected devices by one. At this time, the control device 10 holds information indicating that the USB device 2 relating to the obtained identification information is an unknown device. If the obtained identification information is registered in the list 70 of the already-known identification information, the count value is not changed. Furthermore, if the USB device 2 that is disconnected from the connecting device 11 is an unknown USB device 2, the control device 10 decrements the count value of the counter that counts the number of unknown connected device by one.

An example process for determining whether to shift to the suspended state according to the first modification will be described in detail with reference to the flowchart illustrated in FIG. 8. The control device 10 resets a count value C of the unknown connected device to zero when, for example, the system is started up (Step S100).

At the subsequent Step S101 and Step S102, the control device 10 determines, in accordance with the notice received from the connecting device 11, whether there is a connection of the USB device 2 or a disconnection of the connected USB device 2. Specifically, at Step S101, the control device 10 waits for the occurrence of an event indicating a connection or a disconnection of the USB device 2. If the control device 10 detects the event due to a notice received from the connecting device 11, the control device 10 moves the process to Step S102. At Step S102, the control device 10 determines whether the detected event is a connection event indicating that the USB device 2 is connected to the connecting device 11 or a disconnection event indicating that the USB device 2 is disconnected from the connecting device 11.

If the control device 10 determines that the event that occurs at Step S102 is a connection event, the control device 10 moves the process to Step S103 and performs predetermined connection processes in accordance with processes of, for example, SEQ12 to SEQ15 illustrated in FIG. 5. At this time, the control device 10 obtains identification information on the connected USB device 2. Furthermore, the control device 10 obtains, from the connecting device 11, information indicating a port connected to, for example, the USB device 2 and hold the information indicating the port and the identification information on the USB device 2, in association with each other.

If the control device 10 completes the connection process and moves the process to Step S104, then the control device 10 compares the identification information obtained at the connection process at Step S103 with the list 70 of the already-known identification information that is stored in advance and determines whether the connected USB device 2 is already known. If the identification information obtained at Step S103 has been registered in the list 70 of the already-known identification information, the control device 10 determines that the connected USB device 2 is already known and moves the process to Step S111, which is described later.

In contrast, at Step S104, if the identification information obtained at Step S103 is not registered in the list 70 of the already-known identification information, the control device 10 determines that the connected USB device 2 is not yet known. The control device 10 moves the process to Step S105 and increments the counter value C by one. Subsequently, the control device 10 moves the process to Step S106, holds, in a register, the information indicating that the USB device 2 related to the obtained identification information is an unknown device, and then moves the subsequent process to Step S107.

At Step S107, the control device 10 determines that the state of the connecting device 11 cannot be shifted to the suspended state. Specifically, at this time, because the count value C is not zero, the control device 10 determines that at least a single unknown USB device 2 is connected to the connecting device 11. Then, the process returns to Step S101.

If the control device 10 determines that the event that occurs at Step S101 is a disconnection event, the control device 10 moves the process to Step S108 and performs a disconnection process in accordance with a flow that is not illustrated in the drawing. During this disconnection process, the control device 10 obtains, from the connecting device 11, a port number of the disconnected port and detects the identification information on the disconnected USB device 2 from the obtained port number.

At the subsequent Step S109, in a similar manner as in the process at Step S104 described above, the control device 10 compares the identification information on the disconnected USB device 2 with the list 70 of the already-known identification information and determines whether the USB device 2 is an unknown device. If the control device 10 determines that the USB device 2 is the already-known device, the control device 10 moves the process to Step S111. In contrast, if the control device 10 determines that the USB device 2 is an unknown device, the control device 10 moves the process to Step S110 and decrements the count value C by one. Thereafter, the control device 10 moves the process to Step S111.

At Step S111, the control device 10 determines whether the count value C is zero. If the control device 10 determines that the count value is zero, the control device 10 moves the process to Step S112 and determines that the state of the connecting device 11 can be shifted to the suspended state.

In contrast, if the control device 10 determines that the count value C is not zero at Step S111, the control device 10 moves the process to Step S107 described above and determines that the state of the connecting device 11 cannot be shifted to the suspended state.

If the connecting device 11 is shifted into the suspended state, the bus also shifts to an idle state; therefore, the connected USB device 2 is expected to shift to a power-saving mode. At this time, in the host-side device 1, when only a USB device 2 serving as an internal device is connected to the USB communication device 5 (bus), if a USB device 2 serving as an external device is further connected to the USB communication device 5 (bus), the effect when an attempt fails to shift the USB device 2 serving as the external device to a power-saving mode may possibly affect the operation of the USB device 2, serving as the internal device, that is connected to the same bus.

In such a case, the effect on the USB device 2 that is connected as an internal device depends on the behavior of the USB device 2, serving as the external device, when the attempt to shift the state of the USB device 2 to the suspended state fails. Accordingly, it is difficult to ascertain the degree of effect on the USB device 2 serving as the internal device.

In the first modification, if an unknown USB device 2 is connected to the USB communication device 5, the connecting device 11 does not shift to the suspended state. Accordingly, an attempt to shift to the power-saving mode is not also performed on an unknown USB device 2 connected to the connecting device 11; therefore, there is no need to take into consideration of the effect, due to the failure of the attempt, on the USB device 2 that serves as the internal device.

In the following, a second modification of the present embodiment will be described. In the second modification, in addition to the processes performed in the embodiment described above, of the USB devices 2 connected to the USB communication device 5, the number of USB devices 2 that are connected, as an external device, to the host-side device 1 is counted. Then, only when the number of USB devices 2 that are connected as external devices is zero, it is determined that the state of the connecting device 11 can be shifted to the suspended state. If there is at least one USB device 2 that is connected as an external device, the state of the connecting device 11 is not shifted to the suspended state.

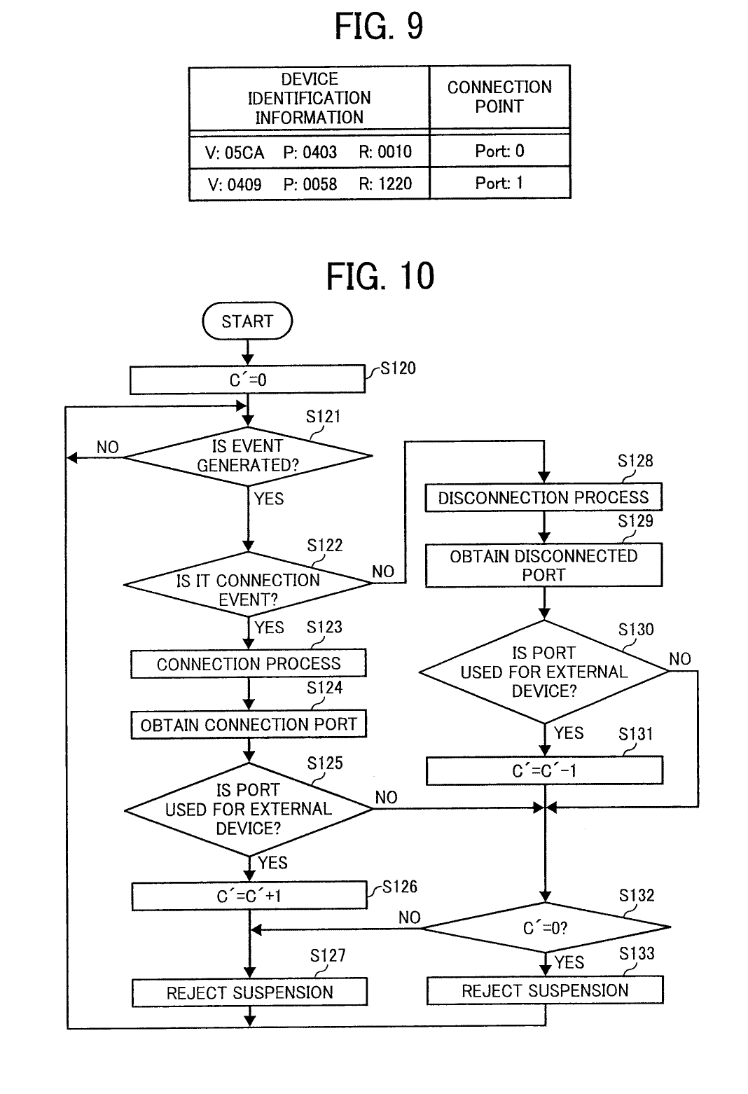

It is possible to determine whether the USB device 2 is connected as an external device or an internal device in accordance with identification information on, for example, the port to which the USB device 2 is connected. For example, for a plurality of ports that are used to connect the USB devices 2, unique information indicating connection points (for example port numbers) is given, and ports that are used to connect the USB devices 2 serving as the external devices are set in advance. Then, as in the example illustrated in FIG. 9, for each connected USB device 2, identification information on the USB devices 2 and connection points to which the USB devices 2 are connected are held in an associated manner.

For example, the determination whether, in accordance with the number of USB devices 2 connected as external devices, the state of the connecting device 11 can be shifted to the suspended state is performed when a process of SEQ16 or SEQ40, illustrated in FIG. 5 and described above, is performed. Then, if it is determined that the number of USB devices 2 connected as external devices is not zero, it is determined that the state of the connecting device 11 cannot be shifted to the suspended state, and the process for shifting to the suspended state at SEQ21 or SEQ41 is not performed.

Specifically, the control device 10 has a counter for counting the number of USB devices 2 connected as external devices and resets the count value of the counter to zero when, for example, the system is started up. If the connecting device 11 detects a connection or disconnection of the USB device 2, the connecting device 11 notifies the control device 10 of the connection point of the port to which the USB device 2 is connected or the port from which the USB device 2 is disconnected. If the port to which the USB device 2 is connected or if the port from which the USB device 2 is disconnected is a port that is used to connect an external device, the control device 10 increments the counter value by one at the time of connection and decrements the counter value by one at the time of disconnection.

An example process for determining whether to shift to the suspended state according to the second modification will be described in detail with reference to the flowchart illustrated in FIG. 10. The control device 10 resets a count value C′ of the number of USB devices 2 that are connected as external devices to zero when, for example, the system is started up (Step S120).

At the subsequent Step S121, the control device 10 waits for the occurrence of an event indicating a connection or disconnection of the USB device 2. If the control device 10 detects the event due to a notice received from the connecting device 11, the control device 10 moves the process to Step S122. At Step S121, the control device 10 determines whether the detected event is a connection event or a disconnection event.

If the control device 10 determines that the event that occurs at Step S122 is the connection event, the control device 10 moves the process to Step S123 and performs a predetermined connection process. In a similar manner as described at Step S103 in the flowchart illustrated in FIG. 8, the connection process is performed in accordance with the process of, for example, SEQ12 to SEQ15, illustrated in FIG. 5. The control device 10 obtains identification information on the USB device 2 that is connected due to the connection process. Furthermore, the connecting device 11 notifies the control device 10 of a connection point indicating the port to which the USB device 2 is connected due to the connection process.

At the subsequent Step S124, the control device 10 obtains, from the notice received from the connecting device 11, a connection point for the port to which the USB device 2 is connected and holds the obtained connection point and the identification information on the USB device 2 connected to the connection point in an associated manner, like that illustrated in FIG. 9.

At the subsequent Step S125, the control device 10 determines whether the port of the connection point obtained at Step S123 is a port that is used to connect an external device. If the control device 10 determines that the port obtained at Step S123 is a port that is not used to connect an external device, the control device 10 moves the process to Step S132, which will be described later.

In contrast, at Step S125, if the control device 10 determines that the port is a port that is used to connect an external device, the control device 10 moves the process to Step S126, increments the count value C′ by one, and then moves the process to Step S127.

At Step S127, the control device 10 determines that the state of the connecting device 11 cannot be shifted to the suspended state. In other words, in this case, because the count value C′ is not zero, it can be determined that a USB device 2 is connected to a port that is used to connect an external device. Then, the process returns to Step S121.

At Step S122 described above, if the control device 10 determines that the event that occurs is a disconnection event, the control device 10 moves the process to Step S128 and performs a disconnection process in accordance with a flow that is not illustrated in the drawing. In the disconnection process, the connecting device 11 notifies the control device 10 of connection information indicating a disconnected port.

At the subsequent Step S129, the control device 10 obtains the connection point of the port from which the USB device 2 is disconnected, which is notified by the connecting device 11. At the subsequent Step S130, the control device 10 determines whether the port of the connection point obtained at Step S129 is a port that is used to connect an external device. If the control device 10 determines that the port is a port that is not used to connect an external device, the control device 10 moves the process to Step S132, which will be described later.

In contrast, at Step S130, if the control device 10 determines that the port is a port that is used to connect an external device, the control device 10 moves the process to Step S131 and decrements the count value C′ by one. Then, the control device 10 moves the process to Step S132.

At Step S132, the control device 10 determines whether the count value C′ is zero. If the control device 10 determines the count value C′ is zero, the control device 10 moves the process to Step S133 and determines that the state of the connecting device 11 can be shifted to the suspended state. In other words, in this case, it can be determined that a USB device 2 serving as an external device is not connected to the connecting device 11.

In contrast, at Step S132, if the control device 10 determines that the count value C′ is not zero, the control device 10 moves the process to Step S127 as described above, and determines the state of the connecting device 11 cannot be shifted to the suspended state.

In the second modification, in a similar manner as in the first modification described above, the connecting device 11 is configured such that, if the USB device 2 is connected to the USB communication device 5 as an external device, the state thereof is not shifted to the suspended state. Accordingly, an attempt of shifting to the power-saving mode is not performed on the USB device 2 that is connected to the connecting device 11 as an external device; therefore, there is no need to take into consideration the effect, due to the failure of the attempt, on a USB device 2 that serves as an internal device.

In the second modification, it is also possible for a configuration such that, when the host-side device 1 is reset upon its starting up, the connection process is performed only on the ports that are used for an internal connection, and then the connection process is performed on the reset of the ports after the devices are reset and shifted to a normal operating state. In such a case, when the number of USB devices 2 connected as external devices is counted, counting can be simply performed only on the USB devices 2 that have been subjected to the connection process after the state of the devices is shifted to the normal operating state.

Below described is an example configuration that can be applied to the embodiment and the modifications.

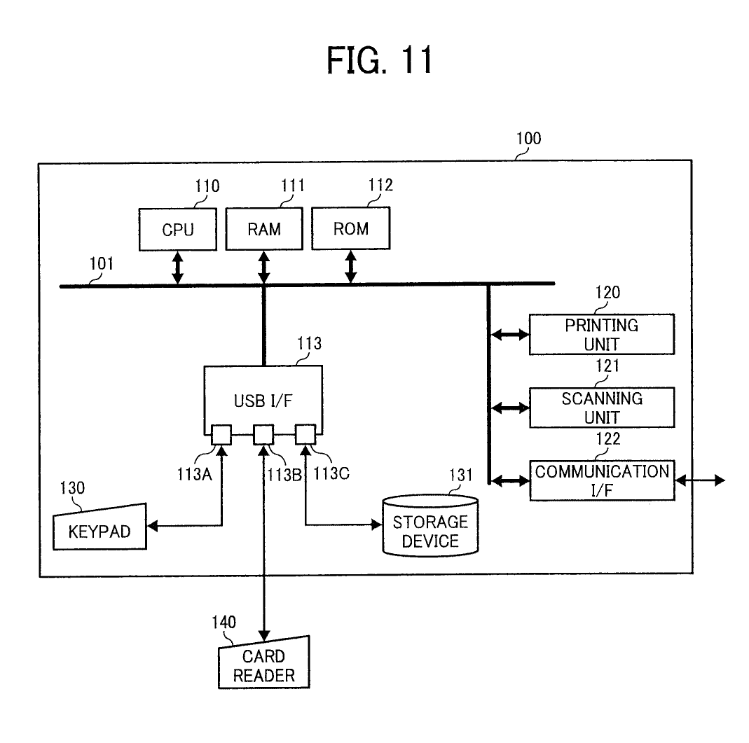

FIG. 11 is a block diagram illustrating, in outline, an example configuration of an MFP 100 serving as the host-side device 1 that can be applied to the embodiment modifications described above. The MFP 100 has a plurality of functions, such as, a copying function, a printing function, a scanning function, and a facsimile function.

In FIG. 11, in the MFP 100, a central processing unit (CPU) 110, a random access memory (RAM) 111, a ROM 112 and a USB I/F 113 are connected to a bus 101. The CPU 110 controls, in accordance with a program stored in the ROM 112 or a storage device 131 that will be described later, the whole operation of the MFP 100 using the RAM 111 as a working memory.

Furthermore, in the MFP 100, a printing unit 120 that is used to print image data, a scanning unit 121 that is used to acquire an image from an original and convert it to image data, and a communication I/F 122 that performs a facsimile communication via a public telephone circuit are connected to the bus 101.

The USB I/F 113 has one port or a plurality of ports and controls the communication with devices that are connected to USB sockets, each corresponding to the ports in accordance with a USB standard. In the example illustrated in FIG. 11, the USB I/F 113 has three USB ports, i.e., a USB port 113A, a USB port 113B, and a USB port 113C, which are identified by unique identification information. The connecting device 11 illustrated in FIG. 4 corresponds to, for example, the USB I/F 113.

In the example illustrated in FIG. 11, internal devices that are installed in the MFP 100 are connected to the USB port 113A and the USB port 113C. For example, a keypad 130 is connected to the USB port 113A, and the storage device 131 is connected to the USB port 113C.

The keypad 130 includes an operating panel that receives instructions from users and a displaying unit that displays in a predetermined manner. The keypad 130 outputs a control signal according to instructions received from the user and supplies them to the CPU 110 via the USB I/F 113. Furthermore, the keypad 130 has a displaying unit that displays information; receives, via the USE I/F 113, a display control signal that is output from the CPU 110; and displays information, in accordance with the display control signal, on the displaying unit.

The CPU 110 controls, in accordance with a program, each unit in the MFP 100 on the basis of the control signal according to instructions received from the users via the keypad 130, enabling the MFP 100 to perform an operation in accordance with instructions from the users. For example, because the CPU 110 controls, in accordance with the instructions received from the users via the keypad 130, the printing unit 120, the scanning unit 121, and the communication I/F 122 in a predetermined manner, the CPU 110 implements the copying function, the printing function, and the facsimile communication of the MFP 100.

The storage device 131 is constituted by, for example, a hard disk drive or a nonvolatile semiconductor memory. The storage device 131 stores therein, for example, image data that is used to print by the printing unit 120, which is sent by the communication I/F 122 as facsimile data or which is obtained by the scanning unit 121. Furthermore, the storage device 131 can store therein a program operated by the CPU 110.

In the USB I/F 113, the USB port 113B is arranged such that an external device can be connected to the MFP 100. In the example illustrated in FIG. 11, a card reader 140 serving as an external device with respect to the MFP 100 is connected to the USB port 113B. The card reader 140 is used to read information contained in an IC card or in a magnetic card and supplies the information that is read from the card to the CPU 110 via the USB I/F 113. For example, it is possible to perform user authentication by reading the user ID, from a card that stores therein a user ID for identifying the user, using the card reader 140; supplying the user ID, which has been read, to the CPU 110; and comparing it with a user ID that is stored in advance.

In the example illustrated in FIG. 11, the card reader 140 is connected to the USB port 113B in a detachable manner. In other words, external devices other than the card reader 140 can also be connected to the USB port 113B. Accordingly, unknown external devices with respect to the MFP 100 may possibly be connected to the USB port 113B. In contrast, for the USB port 113A and the USB port 113C, because internal devices with respect to the MFP 100 are installed thereto, it is assumed that devices unknown by the MFP 100 are never connected to those USB ports.

The program operated by the CPU 110 is provided by storing it in, for example, as described above, the ROM 112 or the storage device 131 in advance; however, the configuration is not limited thereto. For example, the program can be provided by storing it in a compact disk (CD) or a digital versatile disk (DVD), reading them from a drive unit (not illustrated), and then storing them in the storage device 131 or the like. Furthermore, the program can also be obtained by a communication device (not illustrated) via a local area network (LAN) or the Internet and stored, for example, in the storage device 131.

The program for controlling the USBs executed by the host-side device 1 according to the embodiment and the modifications have a modular structure including the above described units, i.e., the control device 10, the communication device 12, and the timer 13. When hardware is actually used, the CPU 110 reads the program from the ROM 112 or the storage device 131 and executes it, whereby each module is loaded into the main storage device (RAM 111), and then the control device 10, the communication device 12, and the timer 13 are created in the main storage device.

In the above explanation, it has been mentioned that the host-side device 1 that can be applied to the present invention corresponds to the MFP 100 in which the printing function, the copying function, and the facsimile function are used in an integral manner; however, the configuration is not limited thereto. For example, the present invention can be applied to another type of electronic device that serves as a host machine for a USB. In particular, the present invention is suitable for electronic devices in which a USB connection is available for internal devices in addition to external devices.

As described above, it has been mentioned that the connection type applied to the present embodiment is a USB connection; however, the connection type is not limited thereto. Specifically, the present invention can be applied to another communication type as long as a communication type has, as described with reference to FIG. 2, a first state in which communication is performed using a bus and a second state in which the bus enters an idle state, and furthermore, the first state further has a third state in which communication using the bus is always available and a fourth state in which, if there is no change in the state of the bus, the state thereof is shifted to the second state.

According to an aspect of the present invention, if, in a first state in which communication can be performed by a connecting device to which another device is connected, a communication request is not received for a predetermined time, the state of the connecting device is shifted to a second state in which communication is not performed so that electrical power consumption of the connecting device is reduced. Accordingly, electrical power consumption on the communication host side can be more effectively reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication device comprising:
a connecting unit that connects another device;
a communicating unit that performs communication with the other device via the connecting unit by using a signal in accordance with a communication request; and
a controlling unit that controls a state of the connecting unit to be in either one of
a first state in which the communication can be performed by the communicating unit and
a second state in which
the communication is not performed by the communicating unit and
electrical power consumption of the connecting unit is reduced,
wherein
the controlling unit shifts the state of the connecting unit from the first state to the second state, when the connecting unit to which the other device is connected is in the first state, and if the communication request to the communicating unit is not received for a predetermined period of time.

2. The communication device according to claim 1,
wherein
the controlling unit returns the state of the connecting unit to the first state, when the connecting unit, to which the other device is connected, is in the second state, and if the communication request to the communicating unit is received.

3. The communication device according to claim 2,
wherein
the first state
has a temporary operating state in which the first state is shifted to the second state in accordance with a period of time after the communication request to the communicating unit is received and
has a normal operating state in which the communicating unit can always perform the communication.

4. The communication device according to claim 3,
wherein,
when the connecting unit is in the normal operating state, and if a request for reducing electrical power consumption of the connecting unit is received, the controlling unit shifts the state of the connecting unit from the normal operating state to the temporary operating state.

5. The communication device according to claim 3,
wherein,
when the connecting unit is in the temporary operating state, and if the communication request to the communicating unit is not received for a predetermined period of time, the controlling unit shifts the state of the connecting unit from the first state to the second state.

6. The communication device according to claim 1,
wherein,
when identification information obtained from the other device to which the connecting unit is connected is not present in a list of already-known identification information that is held in advance, the controlling unit does not shift the state of the connecting unit from the first state to the second state.

7. The communication device according to claim 1,
wherein,
the controlling unit determines whether the state of the connecting unit is shifted from the first state to the second state in accordance with a connection point of the connecting unit to which the other device is connected.

8. The communication device according to claim 7,
wherein,
if the other device is connected to a connection point that is used to perform an external connection out of the connection points, the controlling unit does not shift the state of the connecting unit from the first state to the second state.

9. The communication device according to claim 7, wherein,
if the other device is not connected to a connection point that is used to perform an external connection out of the connection points, the controlling unit shifts the state of the connecting unit from the first state to the second state.

10. A communication control method in a communication device comprising:
communicating, via a connecting unit and by a communicating unit, with another device by using a signal in accordance with a communication request, and
controlling, by a controlling unit, a state of the connecting unit to be in either one of
a first state in which the communication can be performed by the communicating and
a second state in which
the communication is not performed by the communicating and
electrical power consumption of the connecting unit is reduced, wherein
the controlling includes shifting the state of the connecting unit from the first state to the second state, when the connecting unit to which the other device is connected is in the first state, and if the communication request to the communication is not received for a predetermined period of time.

11. A computer program product comprising a computer-usable medium having computer-readable program codes embodied in the medium for processing communication in a communication device, the program codes when executed causing a computer to execute:
communicating, via a connecting unit and by a communicating unit, with another device by using a signal in accordance with a communication request, and
controlling, by a controlling unit, a state of the connecting unit to be in either one of
a first state in which the communication can be performed by the communicating and
a second state in which
the communication is not performed by the communicating and
electrical power consumption of the connecting unit is reduced, wherein
the controlling includes shifting the state of the connecting unit from the first state to the second state, when the connecting unit to which the other device is connected is in the first state, and if the communication request to the communication is not received for a predetermined period of time.
